(19) United States
(12) Patent Application Publication
(10) Pub. No.: US 2006/0178463 A1
(43) Pub. Date: Aug. 10, 2006

(54) Water-based coating

(76) Inventor: Ralph Sacks, Rosemont, IL (US)

Correspondence Address: WELSH & KATZ, LTD, 120 S RIVERSIDE PLAZA, 22ND FLOOR, CHICAGO, IL, 60606, US

(21) Appl. No.: 11/341,731

(22) Filed: Jan. 27, 2006

Related U.S. Application Data
(60) Provisional application No. 60/648,179, filed on Jan. 28, 2005.

(51) Int. Cl. C08K 3/34; B05D 3/02

(52) U.S. Cl. 524/444; 427/393.6; 524/492; 523/402

(57) ABSTRACT

A water-based coating is described comprising colloidal silica and lamellar materials such as glass flakes or mica admixed with a water-based film-forming polymeric carrier such as an epoxy. The water-based epoxy coating can be directly applied to unset, set, cured or uncured concrete and exhibits a water vapor permeance of about 0.14 perms by ASTM F-1869-04. A method for using the coating is also disclosed.

### REFERENCE TO PREVIOUS APPLICATION

This application claims priority of Provisional Application No. 60/648,179, filed Jan. 28, 2005, which is incorporated herein by reference.

### FIELD OF THE INVENTION

The present invention concerns paints and coatings. In particular, the present invention is concerned with water-based coatings and sealants imparting water vapor resistance to surfaces on which they are applied.

### BACKGROUND OF THE INVENTION

When a concrete slab is poured, there occurs a period of setting, which is the initial solidification. After setting, concrete cures over an extended period of time of up to several months. Curing is the process through which the hydration reaction completes, excess water is lost and the concrete develops its strength. It is a common practice to place polyethylene sheeting, fresh straw, or other protective sheeting or substances, over freshly poured concrete and uncured concrete slabs to assist in water retention and curing. Subsequently, polymeric coatings and sealants are often applied to hardened and cured concrete slabs to reduce moisture loss or to effectively waterproof and protect the concrete slab. Generally, further progress, in completing of flooring, and concomitantly construction of a structure, is delayed by days or weeks while the concrete cures because water from the slab can interfere with or damage coatings such as paints and/or adhesives, and flooring such as vinyl or wood. Flooring placed onto sealed floors is delayed as well.

Persons having skill in the art recognize that sealants presently used and known present significant drawbacks. Commonly used waxy sealants, that promote water retention and therefore well-cured concrete, for example, must be removed from the surface before any other material will adhere to the concrete. Such an operation adds to the costs and delays in preparing and finishing a concrete floor and, in no small way, the entire project, or ultimately, the structure.

Sealing and waterproofing also serve to reduce the amount of water that travels from or through concrete into the space where the slab is poured. Water from or passing through concrete, and/or upon its surface, can also interfere with the setting, drying and strengthening of subsequent applications of additional coatings or flooring adhesives.

It would reduce construction delays and improve the strength of the concrete slab if a surface sealant could be applied shortly after the concrete is poured, that is while the concrete is still “green”, that is, if the concrete is in an uncured state.” Further benefits could be realized if the sealant coating can be applied before the concrete sets, while it is still fluid. Additional benefits could be realized if the sealant is convenient to apply using conventional coating techniques and new easy and efficient methods, need not be removed, and can function as both a primer and finish coating in addition to its function as a water vapor barrier.

Presently, vapor barrier sheets or sheathing, like Tyvek™ by Dupont® and foil-lined materials are used for buildings in both hot and cold climates to prevent moisture accumulation within or on walls. These barriers typically cannot be applied to existing structures such as may need remediation due to mold or other moisture damage. It would, therefore, be beneficial if an effective water vapor barrier could be applied to any building surface with the same convenience and ease as standard paint.

It is known in the art that glass flakes can be added to coating systems and products, such as epoxies, to reduce corrosion and increase chemical resistance of the surfaces to which they are applied. For example, coatings containing glass flakes are used to protect steel and other metals exposed to seawater and caustic environments. Although some coatings including glass flakes confer chemical and corrosion resistance, corrosion and most other chemical attacks are not believed to be caused by water alone, but rather by ionic species such as sodium, chloride and other ions in sea water or hydronium ions in acidic solutions.

Known sealants incorporating products such as glass flakes, mica, silica, barium sulfate, pigments or other inert fillers, as are commonly used in the art, are generally not so water-impermeable as to permit their use over uncured concrete that has been coated with such sealants or to serve as a water vapor barrier. That is, carpeting, vinyl flooring and/or wood flooring generally cannot be laid onto uncured concrete that has been treated with sealants, with or without glass flakes, that are presently known in the art.

### SUMMARY OF THE INVENTION

An aqueous polymeric coating or sealant is provided comprising an aqueous polymeric carrier having dispersed therein about 0.5% to about 10% colloidal silica and about 0.5% to about 45% of water-impenetrable lamellar solid material that is chosen from the group consisting of glass flakes, ceramic flakes, mineral flakes, plastic flakes, mica, and mixtures thereof.

In a preferred embodiment of the water-based polymeric coating or sealant the polymeric carrier is chosen from the group consisting of a water-based epoxy, a latex-based coating, and mixtures thereof. In a further preferred embodiment, the preferred lamellar-solid material is glass flakes.

In further embodiments, the polymeric carrier is either a water-based epoxy or a latex-based coating.

In one preferred embodiment, a two-part water-based epoxy coating composition is provided. The coating is composed of two parts, A and B. In preferred formulations, Part A comprises an epoxy resin and a polar organic solvent, and optionally further comprises pigments suspended therein. Part B of the formulation can comprise a hardening agent a water-impenetrable lamellar-solid material chosen from one or more of glass flakes, ceramic flakes, mineral flakes, plastic flakes, mica, or a combination thereof, and colloidal silica. Part B also includes, optionally, a polar organic solvent.

In the present formulation, Part B can further include the addition of water.

Specifically, Part A of the two-part water-based coating composition of the present application can comprise, by volume: about 75% to about 85% of an epoxy resin; about 2% to about 5% of a polar organic solvent; about 3% to about 6% of a silane; about 2% to about 5% pigment; and optionally about 3% to about 6% of an antimicrobial agent. Further, the coating composition can have about 2% to about 9% of a metal silicate. Part B of the composition, can in this specific formulation, comprises by volume: about 30% to about 40% of a curing agent; about 0% to about 6% magnesium silicate; about 0.5% to about 3% glass flakes; about 3% to about 10% of colloidal silica; and about 0% to about 5% silica flour; about 5% to about 15% polar organic solvents; about 1% to about 5% of a surfactant as a mixing aid, and about 30% to about 40% of water. In such a formulation, the two-part water-based coating composition can be made in a ratio by volume of about one Part A to about four parts B.

Alternatively, the coating can be made of two parts, A and B, where Part A comprises by volume about 75% to about 85% of a bisphenol A epoxy resin; about 2% to about 5% tetrahydrafurfuryl alcohol; about 3% to about 6% of silane; and optionally about 2% to about 5% of an antimicrobial agent; about 3% to about 9% of magnesium silicate; and about 1% to about 4% titanium dioxide. Part B of such a formulation contains: about 30% to about 40% of a water-based modified polyamide curing agent; about 2% to about 7% propylene glycol monomethyl ether; about 1% to about 5% of a non-ionic surfactant; about 3% to about 12% magnesium silicate; about 0% to about 3% titanium dioxide; about 0% to about 3% of other pigments; about 0% to about 6% barium sulfate; about 0.5% to about 3% glass flakes; about 0% to about 4% silica flour; about 0% to about 4% benzyl alcohol; about 0% to about 3% tetrahydrafurfuryl alcohol; about 3% to about 7% colloidal silica; about 0% to about 6% isopropyl alcohol, and about 30% to about 40% water. In such a formulation Part A and Part B can each further comprise ethylene glycol.

Further and different mixtures of coatings and sealings can be formulated within the novel scope of the present invention. Further, as it is understood by persons having ordinary skill in the art, it will be understood that the words “coating” and “sealant”, and the variations of those words, including coating, sealing, sealant, seal, coat and other, are herein used interchangeably.

In embodiments of the present invention, the coating or sealing can be applied to freshly poured, partially set or set concrete or other surfaces in any one of the following manner: spray, rolled, painted, squeegeed, poured or other manner. Such variety of application technique provides convenience previously unknown in the application of coating or sealing of surfaces.

### DETAILED DESCRIPTION OF PREFERRED EMBODIMENTS

The present invention contemplates a polymeric sealant formulated to drastically, that is to an unexpectedly high amount, reduce moisture vapor transmission from substrates and surfaces to which it is applied. The surfaces to which the inventive sealant can be applied include freshly poured and unset concrete, “green” (set but uncured) concrete, fully cured concrete, prepared concrete, cement backerboard, cement patch underlayments, terrazzo flooring, drywall, wood, and/or other surface where moisture vapor protection is required.

In a preferred embodiment of the present invention, a two component, water-based, penetrating, epoxy primer is contemplated. This refers to epoxies that include water-compatible hardeners and/or water-compatible resins and can be prepared with water as a component of the formulation.

In another preferred embodiment, the coating is a latex-based coating. The term “latex-based coating” is used in the broad sense to denote water-dispersed polymer emulsions that include natural latex, vinyl acetate latexes, vinyl versatate latexes, styrene butadiene latexes, styrene acrylic latexes, and others, as may be found in so-called latex coatings, latex paints, latex-based caulking, latex paints, latex enamel paints, acrylic latex coatings, water-based enamel paints and others as are known in the art.

It is also known in the art that diverse latex polymers can be added to epoxy coatings and that epoxy resins can be incorporated into diverse latex coatings to optimize properties including viscosity of the uncured coating, and the chemical resistance, light resistance and mechanical flexibility of the final coating film. Certain water-based acrylic latex coatings, such as NEOCAR® Acrylic 850 (available from the Dow Chemical company, Midland, Mich.), approach the durability and chemical resistance of epoxy systems because the acrylic latex polymers self-crosslink. In a particularly preferred embodiment, the polymeric carrier comprises NEOCAR® Acrylic 850.

Throughout, the term “water-based” coating, synonymous with “aqueous” coating, and means that the coating formulation comprises water or is compatible with water as a formulation component. For example, aqueous latex-based coatings are emulsions of hydrophobic polymers in a solvent system that is miscible with water. However, not all latex-based coatings contain added water. Water-based epoxies, such as described in Example 1 below, comprise a water-compatible hardener. Water-compatibility is important because colloidal silica is dispersed in water, and overall water-compatibility aids in surface adhesion and cleanup. By this definition, those of skill in the art will understand that water need not be present at high levels in a complete coating formulation. For example, water comprises only about 18% of the Example 1 composition by weight, and certain latex-based coating formulations have no added water. Polymer systems that are not water-based by this definition include oil-based coatings such as alkyd paints and water-incompatible resins such as vinylesters.

The sealant of the present invention is also adaptable to incorporate anti-microbial agents as desired by the user. A person having ordinary skill in the art will understand that other polymeric carrier systems and polymer-based coatings can be used within the novel scope of the present invention. Further, non-polymeric coatings utilizing the teachings of the present invention, and/or those incorporating polymeric elements and other water sealing or resistance technologies can be utilized without departing from the novel scope of the present invention.

The coating and/or sealant of the present invention, in a preferred embodiment, comprises special water-resistant fillers, such as water-impenetrable flakes and/or colloidal silica, and optionally includes barium sulfate, tints and/or pigments and other fillers that are commonly used in the creation of coatings and sealants. Although barium sulfate, talc, pigments and other fillers can contribute to the overall water resistance of a resulting coating, it is well known from their use in prior art applications over many years that these common coating additives alone, or in combination, are not very effective barriers to water vapor transmission.

Water-impenetrable flakes such as glass flakes, plastic flakes, ceramic flakes, metal flakes, and/or mica, when added to colloidal silica, dispersed in a polymeric carrier, are believed to impart the greatest moisture vapor protection to the inventive composition.

Where incorporated into a water-based polymeric sealant, it can be advantageous for the water-impenetrant flakes to be surface-treated, preferably silane-coated, to improve flake-polymer interactions. It is well understood in the art that different surface treatments and treatment agents impart different characteristics to the flakes. In a preferred embodiment, water-impenetrable flakes are treated with an epoxysilane to facilitate adhesion of an epoxy polymeric carrier. In another preferred embodiment, flakes are treated with an aminosilane or diaminosilane to facilitate interactions with hydrophilic materials. In other preferred embodiments, acrylsilane and/or vinylsilane treatments and agents facilitate interactions between flakes and hydrophobic materials.

In a most preferred embodiment, treatment agents, preferably silanes, are incorporated into the polymeric carrier formulation while the flakes remain untreated.

Glass flakes are an especially preferred water-impenetrable flake. Flakes of chemical-resistant glass, such as borosilicate glass, are especially preferred. Epoxysilane-treated, chemical resistant glass flakes available from Nippon Sheet Glass Co., Ltd., RCF-140T, are especially preferred for their uniform thickness, flatness, advantageous surface treatment and chemical resistance.

The lamellar material, also referred to throughout as, and being synonymous with, ‘flakes’, are platelet-like in shape—that is, they are substantially wider than they are thick, like plates, sheets or fish scales. In preferred embodiments, the flakes range from about 10 microns to about 5 millimeters in width and from about 2 to about 500 microns thick. It is believed beneficial for the flakes to be used in any particular formulation be without substantial curvature and be of similar size. For this reason, a particularly preferred embodiment of the inventive sealant includes “RCF” Microglas® Glasflak® glass flakes from Nippon Glass Sheet Co., Ltd. Another preferred embodiment of the inventive sealant includes mica flakes from 3 mesh to 220 mesh.

It is believed that the lamellar materials help to create the water barrier on a surface to which the inventive coating is applied. As the sealant dries and/or polymerizes, it is believed that the water-impenetrable flakes and colloidal silica particles settle into a water-resistant layer or layers and/or form a matrix that is supported, penetrated, filled and surrounded by the polymeric carrier, such as the exemplary epoxy resin or other polymeric carrier. As is understood in the art, ethylene glycol, propylene glycol, and other alcohols can be used to protect the water-based polymeric sealant from freezing and thereby adapt the polymeric sealant for use in cold conditions.

Although certain examples below discuss the inventive combination of water-impenetrable materials in particular polymeric carriers, it will be readily understood, by one having skill in the art, that other carriers can be used without departing from the novel scope of the present invention. Such other carriers known in the art include, latex-based coatings and acrylic latex-based coatings. Other polymeric coating systems known in the art can also act as polymeric carriers for the water-impenetrable components without departing from the novel scope of the present invention.

The sealant of the present invention, in a preferred embodiment, is formulated so that it can be applied to fresh, “green” concrete as soon as it has achieved initial set, or even applied to unset, freshly poured concrete. Other embodiments of the invention are suitable for application to building materials such as gypsum drywall to supplement or replace other water vapor barriers. Still further benefits and advantages will be apparent to the skilled worker from the disclosures herein.

US Patent Application 2004/0176502 of Raymond et al., published Sep. 9, 2004, at paragraphs 84-85 discloses an epoxy-based concrete sealant with undefined moisture barrier properties. In contrast to that example, in a preferred embodiment of the instant invention, a water-based epoxy polymeric sealant, can be applied directly to green or even fluid concrete. The application in the present invention is made without the required wait of 24 hours for setting of the concrete as described by Raymond et al. at paragraphs 162-165. Further, the instant invention has the unexpected result of reduced water vapor permeance, providing such benefits as the ability of users to apply additional flooring immediately after the coating polymerizes and the concrete sets.

In a further advantage of the preferred water-based epoxy polymeric sealant of the present invention, where Raymond et al. describes pre-treating by brooming or shot-blasting the already set concrete to facilitate sealant adhesion while no such treatment or preparation is required for the instant invention. Still further, the formulations taught in Raymond et al. do not incorporate water-impenetrable lamellar materials or colloidal silica.

As will be apparent to those having ordinary skill in the art, the amount of lamellar materials and colloidal silica in a polymeric carrier can each vary from less than 0.5% w/w (weight per weight) of the sum of the coating formulation to as much as 45% w/w of lamellar material and 15% w/w colloidal silica can be made without departing from the novel spirit and scope of the claimed invention. As is also known in the art, the nature and amounts of other additives and fillers including pigments, thickening agents, and extenders can vary substantially as well, from zero to about 65% w/w of the final formulation without departing from the novel spirit and scope of the claimed invention.

A polymeric sealant of the present invention can incorporate an antimicrobial agent that inhibits the growth of micro-organisms such as bacteria, mold and mildew on the surface of the coating film. One group of antimicrobial agents useful to impart antimicrobial and antiseptic properties to a polymeric sealant made in accordance with the teachings of the present invention, comprise microbe-inhibiting metals including silver, copper, zinc, gold and others as are known in the art, or combinations thereof. In some preferred embodiments, the antimicrobial metal is adsorbed onto microscopic zeolite particles. In some other embodiments, the metal is associated with microscopic zeolite particles by ionic bonding, such that slow ion-exchange will release the antimicrobial metal ions and thereby the anti-microbial properties. In a preferred embodiment, the antimicrobial agent is one of the metal-zeolite complexes sold under the trade name AgION®, which is available as a water-dispersible powder, and is dispersed within the sealant composition along with the other ingredients.

The sealant of the present invention, in a preferred embodiment, is prepared by mixing to homogeneity two components, Part A and Part B, comprising a two-component, water based, penetrating, epoxy primer. In contrast to commercially available products, this sealant is particularly well adapted for application to “green” (set but uncured) concrete. The polymeric sealant according to the invention is believed to be unique in that it can also be applied directly to unset (fluid) concrete. Improved curing and strength of concrete can be realized by increasing the amount of water retained by the cement, the bonding agent of concrete, during the hydration reaction, while simultaneously allowing for other construction to proceed apace without concrete moisture-related delays.

It is believed that as the water or other solvent is lost from the formulation, that is, the water or solvent begins to penetrate into and/or be absorbed by the concrete and/or evaporate, the pores of the concrete are blocked with the finely divided filler materials. As can be seen, then, the colloidal silica and lamellar materials are an important part of this formulation as they are particularly moisture resistant and provide physical, substantially water-impenetrable barriers to water or moisture. The polymerization of the water-based polymer carrier holds and binds the water-impenetrable materials in a durable matrix.

The lamellar material, also referred to throughout as, and being synonymous with, ‘flakes’, are platelet-like in shape—that is, they are substantially wider than they are thick, like plates, sheets or fish scales. In preferred embodiments, the flakes range from about 10 microns to about 2 millimeters in width and from about 2 to about 100 microns thick. Illustrative materials are available under the trademark Microglas® Fleka® from Nippon Sheet Glass Co., Ltd. and have particle sizes of about 0.5 to about 1 mm and are adapted for use with several resins and coupling agents. It is believed beneficial for the flakes to be used in any particular formulation be without substantial curvature and be of similar size. For this reason, a particularly preferred embodiment of the inventive sealant includes “RCF” Microglas® Glasflak® glass flakes from Nippon Glass Sheet Co., Ltd. Another preferred embodiment of the inventive sealant includes mica flakes from 3 mesh to 220 mesh.

It is believed that the lamellar materials help to create the water barrier on a surface to which the inventive coating is applied. As the sealant dries and/or polymerizes, it is believed that the water-impenetrable flakes and colloidal silica particles settle into a water-resistant layer or layers and/or form a matrix that is supported, penetrated, filled and surrounded by the polymeric carrier, such as the exemplary epoxy resin or other polymeric carrier. As is understood in the art, ethylene glycol, propylene glycol, and other alcohols can be used to protect the water-based polymeric sealant from freezing and thereby adapt the polymeric sealant for use in cold conditions.

Modes of application for the inventive polymeric sealant include but are not limited to brushing, rolling, squeegeeing, spraying, and/or other conventional methods of applying liquids to surfaces as are known in the art.

In a preferred embodiment, the colloidal silica is supplied in water that has a preservative added, in some instances the preservative is ethylene glycol. In a further preferred embodiment, polar solvents such as propylene glycol or ethylene glycol are added to protect the formulation or component of the formulation from freezing. In some embodiments, ethylene glycol and/or propylene glycol aid the water-miscibility and dispersion of components of the polymeric coating formulation.

Another aspect of the invention is a method of reducing the amount of water vapor emanating from or passing through a surface coated with the inventive sealant. In the case of “green” concrete, another aspect of the invention is a method to reduce moisture transport from or through the concrete and concomitantly reduce the moisture-related delays between pouring of liquid concrete and subsequent application of additional coatings or flooring materials (e.g., carpet or vinyl and wood tiling) to the concrete slab.

An additional benefit is that a two-component water-based epoxy polymeric sealant according to the invention can act as either a primer or as a highly durable final finish.

In a preferred embodiment of a two-part water-based epoxy polymeric sealant according to the invention, Parts A and B are mixed together in a film-forming ratio. In a preferred embodiment, Part A and Pat B are mixed together in approximately equal amounts by volume. In a particularly preferred embodiment, Parts A and B are mixed together in a ratio of about 1 volume Part A to 4 volumes Part B.

Where the sealant is epoxy-based, Part A comprises the epoxy resin and optionally polar solvents, pigments and fillers. In a further preferred embodiment, Part A comprises, by volume, about 75% to about 85% of an epoxy resin, about 2% to about 5% of a polar organic solvent, about 3% to about 6% of a silane, about 2% to about 5% of a pigment, optionally about 3% to about 6% of an antimicrobial agent, and about 2% to about 9% of a metal silicate. The Part A formulation of a particularly preferred embodiment comprises about 75% to about 85% of a bisphenol A epoxy resin, about 2% to about 5% tetrahydrafurfuryl alcohol, about 3% to about 6% of silane, optionally about 2% to about 5% of an antimicrobial agent, about 2% to about 5% of magnesium silicate, and about 1% to about 4% of titanium dioxide. The exact ratios of these constituents in the Part A formulation of one especially preferred embodiment of the instant invention is found in Table 1. The range of ratios expressed here and within the below descriptions will be understood by a person having ordinary skill in the art to represent a typical range of formulations for the sealant and/or coating of embodiments of the present invention and fall within the novel scope of the present invention. Variations and ranges beyond those expressed herein will be understood to produce formulations that are also within the novel scope of the present invention.

Where in the present invention the sealant is epoxy-based, Part B can comprise the hardening (curing) agent, water-impermeable flakes, colloidal silica and optionally polar solvents, water, pigments, silica powders, mixing aides, and fillers. In a preferred embodiment, Part B comprises by volume about 30% to about 40% of a curing agent, about 0% to about 6% magnesium silicate, about 5% to about 12% pigments other fillers, such as titanium dioxide and barium sulfate, about 0.5% to about 3% glass flakes, about 3% to about 10% of colloidal silica, optionally about 2% to about 5% silica flour, about 5% to about 15% polar organic solvents, about 1% to about 5% of a surfactant as a mixing aide, and about 30% to about 40% of water.

The Part B formulation, in a further preferred embodiment comprises, about 30% to about 40% of a water-based modified polyamide curing agent that is blended with about 2% to about 7% a polar solvent such as propylene glycol monomethyl ether, about 1% to about 5% of a non-ionic surfactant, about 3% to about 12% magnesium silicate optionally including 0% to about 5% magnesium silicate as micro talc, about 0 to about 3% titanium dioxide, about 0% to about 3% other pigments, about 0% to about 6% barium sulfate, about 0.5% to about 3% glass flakes, about 0% to about 4% silica flour, about 0% to about 4% benzyl alcohol, about 0% to about 3% tetrahydrafurfuryl alcohol, about 3% to about 7% colloidal silica, about 0% to about 6% isopropyl alcohol, and about 30% to about 40% clean, fresh water.

In the use of the formulation of a preferred embodiment of the present invention, when

Part B is mixed with Part A, in the case of epoxy polymeric sealants, a mix is obtained that can then be applied to a porous surface such as concrete to form a film upon that surface.

When the inventive polymeric sealant sets and dries, it leaves behind a barrier coating (film) that significantly reduces water vapor transmission from the concrete surface. As described in Example 1, below, the sealant of a preferred embodiment surprisingly reduces moisture-escape from an uncured concrete surface; from about 12 pounds of water per 1000 square feet over 24 hours for sealant lacking fillers to less than about 3 pounds of water per 1000 square feet over 24 hours for sealant including glass flakes and colloidal silica. This reduction in moisture transport, in the case of the exemplary water-based epoxy polymeric sealant containing barium sulfate, glass flakes, colloidal silica and silica flour applied to unset or “green” concrete, is adequate to permit application of additional layers of coatings or floorings days earlier than was previously possible.

It will be understood by those skilled in the art that the references to particular formulations are merely exemplary and that other formulations can be made without departing from the scope of the present invention by varying the particular resins and hardeners, using other polymeric carriers and by varying pigments and inert fillers.

### EXAMPLE 1

Parts A and B were prepared separately by mixing of the components listed in Table 1 (below). Each Part is stable and can be stored e.g., for shipping or prolonged storage. Prior to application, Parts A and B are mixed together in a 1:4 (vol A:vol B) ratio.

TABLE 1
Parts A and B of a two-component water-based epoxy polymeric sealant
according to the teachings of the present invention. “Material” denotes
a commercial, trade, or brand name or identifier. Many of these
are trademarks of the source company. Description denotes the nature
of the component. Weight is in pounds.

| | | | | |
|---|---|---|---|---|
| Material | Description | Weight | Wt./Gal | Gallons |

PART A

| | | | | |
|---|---|---|---|---|
| EPON ™ 828¹ | Bisphenol A epoxy resin | 200 | 9.7 | 20.62 |
| THFA | Tetrahydrofurfuryl | 7.05 | 9.4 | .75 |
| | alcohol | | | |
| Z6040² | Silane | 10.0 | 8.9 | 1.12 |
| R902 | Titanium dioxide - | 27.2 | 34 | .80 |
| | tint | | | |
| AgION ™³ | Anti-microbial | 20 | 17.51 | 1.14 |
| | agent, OPTIONAL | | | |
| 45/26 | Magnesium silicate | 18.0 | 22.5 | .80 |
| 30/36 | Micro talc | 9.0 | 22.5 | .40 |
| TOTAL | | 291.25 | 11.36 | 25.63 |

PART B

| | | | | |
|---|---|---|---|---|
| Epilink 360⁴ | Modified Polyamide | 294.12 | 8.8 | 33.42 |
| | curing agent | | | |
| Dowanol ™ PM⁵ | Propylene glycol | 36.12 | 7.65 | 4.72 |
| | monomethyl ether | | | |
| Igepal ® 630⁶ | Non-ionic surfactant | 21.3 | 8.8 | 2.42 |
| 45/26 | Magnesium silicate | 98.1 | 22.5 | 4.36 |
| 30/36 | Micro talc | 49.05 | 22.5 | |
| R902 | Titanium dioxide - | 65.28 | 34 | 1.92 |
| | tint | | | |
| Green Iron | Pigment | 57.94 | 42.6 | 1.36 |
| Oxide 307 | | | | |
| Blanc Fixe | Barium sulfate | 140.0 | 33 | 4.24 |
| MicroGlas ® | Glass Flakes | 20.85 | 20.85 | 1.0 |
| Glasflake ® | | | | |
| RCF-160⁷ | | | | |
| Silcosil 106⁸ | Silica flour | 33.75 | 22.5 | 1.5 |
| | Benzyl Alcohol | 20 | 8.7 | 2.3 |
| THFA | Tetrahydrafurfuyl alcohol | 2.82 | 9.4 | .3 |
| Nalco 75⁹ | Colloidal silica | 55 | 10.74 | 5.12 |
| IPA | Isopropyl alcohol | 36.12 | 6.84 | 5.28 |
| Water | | 269.4 | 8.34 | 32.31 |
| TOTAL | | 1199.85 | 11.71 | 102.43 |

¹Available from Resolution Performance Products.
²Available from Troy Chemical Co.
³Available from AgIon Technologies, Wakefield, MA.
⁴Available from Air Products, Inc., Allentown PA.
⁵Available from The Dow Chemical Company, Midland, MI
⁶Available from Sigma-Aldrich, St. Louis, MO and others. Igepal ® is a registered trademark of Rhone-Poulenc AG Co.
⁷Available from FRP Services & Co. (America) Inc. White Plains NY, US distributor for Nippon Sheet Glass, Co. Ltd., Tokyo, Japan
⁸Available from U.S. Silica Company, Berkeley Springs, WV
⁹Available from Nalco Industries, Naperville IL.

Relative to the same base epoxy formulation lacking pigments, barium sulfate, or other fillers, this exemplary sealant reduces moisture escape from the concrete surface from about 12 pounds of water per 1000 square feet over 24 hours to about 2 pounds of water per 1000 square feet over 24 hours, as measured according to the ASTM F-1869-04 anhydrous calcium chloride test. Addition of pigments and fillers to make the formula colored and opaque reduced moisture escape from the concrete surface to only about 7 lbs per 1000 square feet per 24 hours. Subsequent addition of barium sulfate, used primarily as a thickening agent and filler, to the level in Table 1 reduced moisture escape to about 5 lbs. Subsequent addition of glass flakes as in Table 1 reduced moisture escape to 3.5 lbs. Subsequent addition of colloidal silica reduced moisture escape to about 2 lbs per 1000 square feet per 24 hours, well below the 3 lb limit required for application of flooring materials.

Experimental Results

Testing by ASTM E-96 wet cup method gave values of water vapor transmission of 0.06 (grains per square foot per hour), and water vapor permeance, often referred to as the “perm rating”, of 0.14 (grains per square foot per mm Hg per hour). This compares very favorably to that provided by: Tyvek™ Housewrap manufactured by Dupont, having a perm rating of >90; or even 2 and 4 mil polyethylene sheeting used as building vapor barriers having perm ratings of 0.16 and 0.08, respectively. [“Building in Alaska. Permeability of common building material to water vapor.” (University of Alaska Fairbanks Co-operative Extension service publication EEM-00259, Reprinted October 2000)]

In another test by ASTM D-1653, this exemplary sealant containing less than 2% w/w glass flake reduced water vapor permeability to 4×10⁻⁴ grams water per square meter per millimeter of mercury per day (gr/m²·mmHg·day), as compared to reported values 1.73×10⁻² gr/m²·mmHg·day measured for a sealant containing 25% w/w glass flakes in a vinylester resin and 0.82 gr/m²·mmHg·day for a sealant containing 45% w/w glass flakes in a vinylester resin.

### EXAMPLE 2

### Latex-Based Coating

To a vinyl acetate latex-based coating, the polymeric carrier, is added 2% w/w glass flakes, and 4% w/w colloidal silica. When applied to standard gypsum drywall to achieve a dried thickness of 2 mils (0.002 inches), water permeance is reduced from greater than 5 perms of the original latex-based paint carrier to below 2.5 perms for the latex-based paint carrier containing glass flakes and colloidal silica.

### EXAMPLE 3

### Acrylic-Based Coating

To an exterior acrylic-based housepaint coating, the polymeric carrier, is added 2% w/w glass flakes, and 4% w/w colloidal silica. When applied to standard drywall to achieve a dried thickness of 2 mils (0.002 inches), water permeance is reduced from greater than 5 perms of the original acrylic-based paint carrier to below 2.5 perms for the acrylic-based paint carrier containing glass flakes and colloidal silica.

### EXAMPLE 4

### Acrylic Latex-Based Concrete Sealant

To a formulation comprising 43.17 gallons (375.6 pounds) NEOCAR® Acrylic 850 latex, 54.58 gallons (454.7 pounds) water, and 2.25 gallons (16.9 pounds) UCAR® Filmer IBT is added 5.12 gallons (55 pounds) Nalco 75 colloidal silica and 2 gallons (46.9 pounds) 100 mesh mica. Compared to the sealant lacking colloidal silica and mica, the coating provides more than 30% lower water permeance.

Each of the patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

I claim:

1. A polymeric sealant composition comprising an aqueous polymeric carrier having dispersed therein:
a) about 0.5% to about 15% by volume of colloidal silica; and
b) about 0.5% to about 45% by volume of a water-impenetrable lamellar solid material selected from the group consisting of glass flakes, ceramic flakes, mineral flakes, plastic flakes, mica and mixtures thereof.

2. The polymeric sealant according to claim 1 where said aqueous polymeric carrier is selected from the group consisting of a water-based epoxy a latex-based coating and mixtures thereof.

3. The polymeric sealant according to claim 2 where said water-impenetrable lamellar solid material is glass flakes.

4. The polymeric sealant according to claim 1 where said water-impenetrable lamellar solid material is mica.

5. The polymeric sealant according to claim 1 where said aqueous polymeric carrier is a water-based epoxy.

6. The polymeric sealant according to claim 1 where said aqueous polymeric carrier is a latex-based coating.

7. The polymeric sealant according to claim 6 where said aqueous polymeric carrier is an acrylic latex-based coating.

8. A two-part water-based coating composition comprised of two parts, Part A and Part B:
where Part A comprises;
a) an epoxy resin;
b) a polar organic solvent;
c) and optionally present pigments;
and Part B comprises;
a) a hardening agent;
b) about 0.5% to about 45% water-impenetrable lamellar solid materials selected from the group consisting of glass flakes, ceramic flakes, mineral flakes, plastic flakes, mica and mixtures thereof;
c) about 0.5% to about 10% of colloidal silica
d) and optionally further comprising a polar organic solvent.

9. A two-part water-based coating composition comprised Part A and Part B, where said Part A comprises by volume:
a) about 75% to about 85% of an epoxy resin;
b) about 2% to about 5% of a polar organic solvent;
c) about 3% to about 6% of a silane;
d) about 2% to about 5% pigment;
e) about 0% to about 6% of an antimicrobial agent; and
f) about 2% to about 9% of a metal silicate; and
Part B comprises by volume:
a) about 30% to about 40% of a curing agent for said epoxy resin;
b) about 0% to about 6% magnesium silicate;
c) about 0.5% to about 3% glass flakes;
d) about 3% to about 10% of colloidal silica;
e) about 0% to about 5% silica flour
f) about 5% to about 15% polar organic solvents;
g) about 1% to about 5% of a surfactant as a mixing aide; and
h) about 30% to about 40% of water.

10. The two-part water-based coating composition of claim 9 where Part A and Part B are admixed in a ratio by volume of about one volume of Part A to about four volumes of Part B.

11. A two-part water-based coating composition comprised of Part A and Part B, where Part A comprises by volume:
a) about 75% to about 85% of a bisphenol A epoxy resin;
b) about 2% to about 5% tetrahydrafurfuryl alcohol;
c) about 3% to about 6% of silane;
d) optionally about 2% to about 5% of an antimicrobial agent;
e) about 3% to about 9% of magnesium silicate;
f) and about 1% to about 4% titanium dioxide; and
Part B comprises by volume:
a) about 30% to about 40% of a water-based modified polyamide curing agent for said epoxy resin;
b) about 2% to about 7% propylene glycol monomethyl ether;
c) about 1% to about 5% of a non-ionic surfactant;
d about 3% to about 12% magnesium silicate;
e) about 0% to about 3% titanium dioxide;
f) about 0% to about 3% other pigment;
g) about 0% to about 6% barium sulfate;
h) about 0.5% to about 3% glass flakes;
i) about 0% to about 4% silica flour;
j) about 0% to about 4% benzyl alcohol;
k) about 0% to about 3% tetrahydrafurfuryl alcohol;
l) about 3% to about 7% colloidal silica;
m) about 0% to about 6% isopropyl alcohol; and
n) about 30% to about 40% water.

12. The two-part water-based coating composition of claim 11 where Part A further comprises about 0.25% to about 5% of a preservative that is one or both of ethylene glycol and propylene glycol.

13. The two-part water-based coating composition of claim 12 where Part B further comprises about 0.25% to about 5% of a preservative that is one or both of ethylene glycol and propylene glycol.

14. The two-part water-based coating composition of claim 12 where Part A and Part B are admixed in a ratio by volume of about one volume of Part A to about four volumes of Part B.

15. A method of reducing water vapor permeance of a surface that comprises applying the polymeric sealant of claim 1 to said surface.

16. The method of reducing water vapor permeance of a surface of claim 15 where said surface is a concrete surface.

17. A method of reducing water vapor permeance of a surface that comprises applying the polymeric sealant of claim 12 to said surface.

18. The method of claim 17 where said surface is a concrete surface.

19. The method of claim 18 where said surface is an unset concrete surface.

20. A method of reducing water vapor permeance of a surface that comprises applying the polymeric sealant of claim 6 to said surface.

21. The method of claim 20 where said surface is a surface of a wall.
